(19) United States
(12) Patent Application Publication
(10) Pub. No.: US 2010/0138281 A1
(43) Pub. Date: Jun. 3, 2010

(54) System and method for retail store shelf stock monitoring, predicting, and reporting

(76) Inventors: Yinying Zhang, Pleasanton, CA (US); Daxing Ren, Pleasanton, CA (US)

Correspondence Address: Yinying Zhang, Suite 186, 2843 Hopyard Road, Pleasanton, CA, 94588, US

(21) Appl. No.: 12/590,577

(22) Filed: Nov. 10, 2009

Related U.S. Application Data
(60) Provisional application No. 61/199,081, filed on Nov. 12, 2008.

(51) Int. Cl. G06Q 10/00; G06Q 30/00; G06Q 50/00

(52) U.S. Cl. 705/10; 705/28; 705/22

(57) ABSTRACT

A system for retail store shelf stock status monitoring, predicting, and reporting that is capable of monitoring retail store current shelf stock capacity and shelf product freshness at product level, category level, department level, store level, and other product hierarchy levels. It is also capable of intelligently predicting future shelf stock status according to predicted future store sales activities. It uses shelf stock empty index, out-of-stock alert, shelf stock freshness, shelf stock expiration alert, and other shelf stock performance measures to present current shelf status, future shelf status, and past shelf stock performances through interactive store maps and other visual presentation means to optimally deliver retail store shelf stock performance information in real time. The system empowers store clerks, store managers, chain store management, and corporation analysts to monitor, review, and analyze store shelf stock status in real time from anywhere at any time.

### CROSS-REFERENCE TO OTHER PATENT APPLICATIONS

This application claims the benefit of the Provisional Application No. U.S. 61/199,081, filed Nov. 12, 2008.

### DESCRIPTION

### Background of the Invention

In retail industry, one of the long standing problems is out-of-stock on store shelves. According to market analyses, retail stores worldwide have an average out-of-stock ratio around 7-10%, See, Elena Pasquali, “Shopper, Shelves and Supply Chains” published on Mar. 3, 2008, on www.foodinternational.net. Such high out-of-stock rate costs the retail industry billions of dollars of sales loss each year. Another long standing problem is out-of-date perishable grocery products, which costs grocery retailers hundreds of million dollars each year because many of the expired foods or near expired foods have to be scrapped or be sold at discounted prices, See, “Expired Product Project” 2003 report. Although the retail industry has been struggling with these problems for years, there is little improvement yet. In fact, the out-of-stock problem is getting worse according to the latest market analysis. In many cases, store front shelves have been out-of-stock for a long time but the backroom is full of stocks because either out-of-stocks were not noticed or there were no enough floor workers to bring the backroom stocks to the front shelves. In other cases, front shelf out-of-stocks are caused by inventory out-of-stocks in the backroom. While inventory out-of-stocks are commonly believed to be a supply chain management issue, it is should be understood that the true root cause is the lack of dynamic response of supply chain management to the store front sales activities. Meanwhile, out-of-date events of perishable products have similar root causes. In many cases, expired products remain on store front shelves without being noticed. Such situations severely damage store images. In other cases, too many expired or near expired perishable products remain in backroom. They have to be scrapped eventually. Although there are many root causes for out-of-stocks and out-of-date products, one problem in common is that there is currently no effective means to monitor and manage store front shelf stocks.

Radio frequency identification (RFID) system has been widely perceived as the solution for monitoring product movement including monitoring products on store front shelves. However, latest research found the RFID technology is not accurate for grocery product monitoring. In many cases, it is even not capable of monitoring some of the grocery products such as frozen food and canned food, See, excerpt of “RFID Progress in Retail to Mid 2007”, published on May 29, 2007, on IDTechEx.com. To those products that the RFID technology is compatible, it may have issues with the cost effectiveness. Recently, a major household product supplier discontinued its pilot program for implementing the RFID system for its products at a major general merchandize chain store without explaining the reason, See, “P&G halts tagging of promotional displays” published on Feb. 16, 2009, on www.retailcustomerexperience.com. There are many other techniques that have been disclosed for monitoring store front shelf stocks. However, they are either not accurate or not cost effective. Alternative solutions are still in demand.

Besides shelf stock monitoring problems, there are equally long standing problems in shelf stock status reporting. With tens of thousands of products actively for sale in a typical grocery retail store, how to present the shelf stock status becomes a true challenge. Moreover, major chain stores have hundreds or even thousands of retail stores. The monitoring or reporting systems need concise and consistent measures to present the most critical shelf stock information to the store operators and upper management in a timely fashion. There are currently no effective methods for measuring shelf stock status or shelf product freshness status for higher product hierarchy levels, such as at category, department, and store levels. It is desirable to have a system that can measure overall shelf stock status and product freshness at any given product level.

In summary, out-of-stocks and out-of-date products can be prevented or greatly reduced if there is a shelf stock management system that can monitor store front shelf stocks and alert store staff in the events of out-of-stocks or out-of-date products. It is more desirable that the system can predict out-of-stock and out-of-date product events to give store staff ample time to respond to the potential problems and take appropriate actions to prevent them from happening. It is also desirable that the system can store shelf stock status data and use consistent and intuitive measures to provide shelf stock performance reports at all product hierarchy levels to help store staff, corporation analysts, and higher level management to quickly gain knowledge of store front shelf stock performances and discover problematic products, operation problems, and changes of market to develop long term solutions.

### SUMMARY OF THE INVENTION

The present invention is related to systems and methods for retail store shelf stock status monitoring, predicting, and reporting. The system according to the present invention is capable of monitoring retail store current shelf stock capacity and shelf product freshness at product level, category level, department level, store level, and other product hierarchy levels. It is also capable of intelligently predicting future shelf stock status according to future store sales activities. It uses concise and consistent shelf stock performance measures to present current shelf status, future shelf status, and past shelf stock performances through interactive store maps and other visual presentation means to optimally deliver shelf stock performance information in real time. The system can increase store sales profits by preventing or reducing sales losses due to out-of-stocks and out-of-date products. The system empowers store clerks, store managers, chain store management, and corporation analysts to monitor, review, and analyze store shelf stock status in real time from anywhere at any time. Furthermore, the system can significantly improve retail store operation visibility and accountability, and improve store management efficiency.

### DETAILED DESCRIPTION OF THE INVENTION

The present invention greatly improves store sales management visibility and problem correction ability for retail stores, especially retail chain stores, through a system that store staff can monitor store front shelf stocks, shelf item freshness, store sales, market changes, and inventory supply status at any product hierarchy level (from single store and single product to entire chain store and all categories of products) in real time. The system can help retail management at all levels at any place quickly find problems happening in the store front and make timely corrective actions. It can also help improve store sales and customer shopping experience by preventing and reducing out-of-stocks and out-of-date products on shelves.

The system consists of five integrated functional subsystems that provide essential capabilities for retail store shelf stock monitoring, prediction, reporting, and analysis.

The system according to present invention comprises a data processing subsystem which resides in hosting database server and can automatically receive, acquire, and manipulate store front sales transaction data, store backroom inventory data, store front shelf stocks data, product information data, and other relevant data from various data sources to transform these data into ready to use formats for store shelf stock status monitoring, future shelf stock status prediction, past shelf stock performance analysis, out-of-stocks and expiration alerts, and for many other applications. The data processing subsystem has the capability to automatically execute precompiled procedures at prearranged time and sequence. Such data processing system can significantly reduce human labor and improve reliability, accuracy, and consistency in data manipulation.

The system according to present invention comprises a store shelf stock monitoring subsystem that retrieves store front current shelf stock status data from database and displays store front current shelf stock status in web based pages in tables, charts, maps and other easy-to-understand formats. Special signs or symbols are used to indicate if a product is in full stock, near out-of-stock, or out-of-stock status, and to indicate if there are any items near expiration or already out-of-date. Such shelf stock status information is critical to retail store operation to avoid sales loss or damages of store image. More importantly, when such information is presented to store management at all levels, appropriate actions can be taken to correct problems or prevent problems from happening, which significantly increase store operation visibility and responsibility.

The system according to present invention comprises an early warning and notification subsystem that utilizes advanced telecommunication technologies to ensure any problems or potential problems of store front shelf stock performance can be identified and handled appropriately. It uses color signs, symbols, gauges, and rulers to visually display different shelf stock status to catch store operators' attention. Alternatively, it issues alert messages to relevant personnel through phone calls, emails, text messages, and other means to reach the responsible person or persons for taking necessary actions in the event of an abnormal situation that either has happened or is about to happen.

The system according to present invention comprises a store shelf stock status predicting component (subsystem) that can predict future shelf stock status based on current shelf stock status, predicted future store sales activities, and historical sales patterns. Such predicting abilities are built on statistic modeling models, best known practices, and automatic computer processes. Future shelf out-of-stocks or future events of expiration of perishable products can be predicted by the subsystem automatically. The predicted data are displayed on designated user interface pages through tables, charts, and maps. Predicted future or near future events of out-of-stocks and expiring perishable products on shelves are displayed by special warning signs to catch store operators' attention. Alert messages will be sent out to responsible personnel for taking preventive actions. Such proactive actions can greatly prevent unwanted events from happening and improve retail store manageable ability.

The system according to present invention comprises a subsystem for generating store shelf stock performance analytical reports for retail store management, analysts, and products suppliers to review or analyze past store shelf stock performances for problem finding or management improvement. Past performances can be viewed through web based reporting pages. The system further provides users with user configurable interactive pages allowing users to conduct self-defined analyses by adjusting or imputing user selected parameters. Such flexibility empowers management, analysts, and products suppliers to gain insights of store sales performance through in-depth analyses of store shelf stock performances.

For facilitating future shelf stock status prediction, methods for building store sales baselines are disclosed. According to present invention, sales baselines are built from store historical sales data. For more accurate prediction, methods for deriving special day sales impact factors are disclosed. Special day sales impact factors can be used for adjusting estimated future sales on special days such as the days having major promotions, special local events, extreme weather conditions, and major holidays. Future sales and future shelf stock status at a given future time can be estimated according to current shelf stocks, current store sales volumes, sales baselines, and impacts of special days if applicable.

The system according to the present invention comprises a store sales simulator that can generate store sales data by simulating store sales transactions. In many situations, retail store management and analysts need to understand future market trends at given market conditions, such as they may want to know what impacts a proposed promotion will be on the store future sales. They can use the store sales simulator to generate sales data based upon historical sales baselines and impacts of the proposed promotion. By doing so, retail store management and analysts can refine their promotion plans to optimize return of investment. Another application is to use the store sales simulator to mimic store sales activities in real time to allow application developers to develop and test analytical tools without impacting store production data service systems. The simulator can significantly save resources and provide great convenience for retail application tool development.

The following detailed examples describe certain embodiments for retail store shelf stock status monitoring, predicting, and reporting by the disclosed system. They are intended to be illustrative rather than exclusionary:

### Example 1

Methods for monitoring current shelf stock status at unique product (represented by its universal product code, UPC) level are explained in detail below.

In monitoring shelf stocks, the most fundamental parameters are the current shelf item count and the full stock item count. According to present invention, the current shelf item count of a UPC is estimated by subtracting sold item count of the UPC from the full stock item count or the item count actually received from replenishment device. Whenever a shelf stock is replenished, a full stock flag signal or actual item count will be sent to shelf replenishment data table. The system can use this updated replenishment information and point-of-sale information to calculate shelf item count for each UPC in real-time. The full stock item count of each UPC is a static number available from shelf space allocation. The sold item count is available from records of store point-of-sales (POS). Accordingly, a computer program can use replenishment and POS records from database to calculate the UPC item count on the shelf.

In reality, customers may pick up items and check them out 20 minutes later or longer. During this time period, although the system may indicate there are certain items available on shelf but the shelf may have been out-of-stock for some time already. To minimize the impact of this kind of reality, one can adjust the sold item count dynamically according to current customer shopping activities such as the checkout rate at point-of-sales. Alternatively, one can use 20 minute or later future shelf item count predicted by the system for future time such as 20 minutes or later.

The methods can be used for estimating shelf stock item count for a large number of UPCs by using automatic data feeding and computation processes to generate a data table or tables containing current shelf stock item counts for all UPCs in the store. To facilitate such data manipulation, any types of data servers can be used once they can provide enough database space and have enough capacity and bandwidth to handle the data volume. One of such data servers is Microsoft SQL Server 2005 available from Microsoft which can provide needed data processing capability and automation capability required for shelf stock monitoring, predicting, and reporting according to system disclosed by the present invention.

In the reporting system according to the present invention, shelf stock capacity, shelf stock alert level, and shelf stock empty index are used to measure a product shelf stock performances. Shelf capacity (current shelf item count divided by full stock item count) measures how full the shelf stock is. Shelf alert level indicates how severely a UPC is approaching out-of-stock (empty shelf stock) or near out-of-stock status The shelf stock empty index also measures how severely a UPC is to approaching out-of-stock or near out-of-stock but with the additional ability to measure how long the UPC has been in the out-of-stock or near out-of-stock states.

A method according to the present invention for assigning UPC current shelf stock alert level consists of the following steps: (1) retrieving current shelf stock item count of the UPC; (2) dividing the current item count by the full stock item count of the UPC to get the UPC current shelf stock capacity; and (3) assigning an alert level to the UPC according to its shelf stock capacity (the lower the capacity the higher the alert level).

For example, an alert system with 5 alert levels is used by the present invention for representing shelf stock status. By which, alert A is assigned to shelf stock capacity at zero (out-of-stock); alert B is assigned to shelf stock capacity between 0% and 20% (near empty); alert C is assigned to shelf stock capacity between 20% and 40%; alert D is assigned to shelf stock capacity between 40% and 70%; and alert E is assigned to shelf stock capacity between 70% and 100% (full or near full stock)).

A method according to the present invention for deriving current shelf stock empty index for a UPC consists of the following steps: (a) retrieving the UPC current shelf stock alert level from database; (b) retrieving predefined weight number for that alert level; (c) dividing the weight number of current alert level by the largest weight number predefined for the highest alert level (Level A) to get a relative alert level number; and (d) multiplying the relative alert level number by a factor of 100 to get an index number between 0 and 100. This index number is the current shelf stock empty index number of the UPC.

Active web pages according to the present invention are used to present the shelf stock capacity, shelf stock alert levels, and shelf stock empty index by dynamically retrieving the data from database. The displayed data are organized in interactive tables, charts, and maps. The web page services are supported by a website server. Any types of website servers can be used once they can provide services for dynamic page update. One commonly used website server is Internet Information Server (IIS) hosted on Windows Server 2003 available from Microsoft. The web pages can be automatically refreshed by timers to reflect most current shelf stock status while the data table or tables storing the shelf stock status data can be dynamically updated at predetermined time intervals by database server through stored procedures. Automatic page refreshment can be achieved by using any available internet technologies. ASP.NET and AJAX available from Microsoft are used to provide smooth and partial page update according to the present invention.

### Example 2

Methods for using interactive store map for presenting store shelf stock status are explained in detail below.

The present invention takes advantages of commercially available webpage based map engines to provide basic map functionalities for the store map. One of the most commonly used map engines is Dundas Map for .NET available from Dundas Data Visualization, Inc. Any other map engine may be employed once they can provide the functionality for zooming, panning, data binding, dynamic update, user selectable content display, and other desirable features.

To present store shelf stock status by the interactive store map, each product or UPC is represented by a symbol. The symbol is located at the location corresponding to its shelf location inside the store. Product name, item counts, product price, current shelf capacity, shelf stock alert level, shelf stock empty index, product freshness score, expiration alert level and other product information are dynamically bonded to the symbols through data binding.

In order to unitize the geographic map tools (such as the one from Dundas) for indoor shelf location and product shelf status display, the coordinates of shelve floor location and UPC shelf location are converted to geographic location coordinates. The conversion is achieved by using a cross reference table and stored procedures in a database server. The shelf shapes can be dynamically generated through webpage codes or downloaded from shape files. It is preferred to download from a shape file. The UPC symbols are dynamically bonded to UPC shelf location coordinates through dynamic data binding technology since the color, shape, size, and location for each product change dynamically. The UPC symbols used in the map are optimally represent product or UPC shelf status, such as red color is used for warning store operators for out-of-stock events, yellow color for alerting potential out-of-stock situation, while green color is used for indicating normal shelf stock status.

The interactive store map can be used for display shelf store capacity, shelf stock empty index, and shelf stock alert level at UPC level. It can also be modified to display these measures at higher product hierarchy levels, such as at category, department, or store levels. In addition, it can also present other types of shelf stock status like perishable products freshness scores and expiration alert levels to be discussed in later sections.

### Example 3

Methods for monitoring current shelf stock status at store level are explained in detail below.

A retail chain may have several hundred or even several thousand retail stores. It is not practical to micromanage each product at single store and single UPC level. To facilitate macro management, methods for aggregating product shelf stock status data to higher hierarchy levels such as category level, department level, store level, district level, and even entire chain are disclosed by the present invention. Below is an example of aggregating UPC shelf stock empty index data to store level for overall store shelf stock status monitoring.

A method according to the present invention for deriving current shelf stock empty index number at store level consists of the following steps: (a) counting the numbers of UPCs that are at shelf stock alert levels A, B, and C (the top 3 alert level) separately; (b) assigning a weight number to each alert level (the higher the alert level, the larger the weight); (c) calculating the weight adjusted grand total number of all UPCs at the top 3 alert levels; (d) dividing the weight adjusted grand total number by the total number of UPCs in the store for sales and the largest weight number (weight number for alert A) to get a relative number; and (e) multiply the relative number by a factor of 100 to get an index number between 0 and 100. This number is the empty index number for the store.

A method according to the present invention for assigning current shelf stock empty alert level to a store consists of the following steps: (a) deriving current shelf stock empty index for the store per previous described procedures; (b) assigning an alert level to the store according to its current shelf stock empty index (the higher the index, the higher the alert level).

### Example 4

Methods for predicting future sales at UPC level are explained in detail below.

To predict future shelf stock status, the system will need to estimate how many items will be sold from current time to the considered future time. Disclosed by the present invention is a novel approach by using sales baseline built from a store historical sales data and dynamically adjusting for special day impacts such as by major promotions and holidays.

Sales baseline is a basic element in predicting future sales. Sales baseline can be built in small or large time intervals. For fast selling products, small time intervals (minutes) are preferred, while longer time intervals (days or weeks) can be used for slow selling products. For typical products, sales baseline data points should be calculated at small time intervals (from 1 minute to a few hours). Preferably, the time interval is between 10 minutes to 1 hour.

Retail sales typically have daily cycling pattern within working hours, weekly cycling pattern within 7 days, and seasonal cycling pattern within in a year. Therefore, there are different sales baselines can be built for different applications for future sales prediction. Typically, they are daily, weekly, and yearly sales baselines. Since each UPC has different sales pattern, one should build the sales baselines for each UPC. Alternatively, general sales baselines (or called standard sales baselines) can be built and be applied to all products for future sales prediction. Understandably, predictions based on the general sales baselines will be less accurate. However, they have the advantages of labor saving and ease of use. To improve prediction accuracy, one can group the products by their sales patterns, and build generic sales baselines for each group. Preferably, one builds unique sales baselines for each UPC. More preferably, one builds 4 weekly sales baselines with hourly sales of each day for each UPC to be used at the 4 different seasons for more accurate prediction of future sales.

A method according to the present invention for building a weekly sales baseline with hourly sales of each day for a UPC consists of the following steps: (a) retrieving historic sales data for the UPC from the months in a same season; (b) trimming out the data from special days (e.g., major promotions, special local events, extreme weather conditions, and major holidays); (c) grouping the trimmed data by the days in a week and by the working hours in a day; (d) calculating the average sales for each working hour in each day of a week; and (g) saving weekly sale baseline data in a database for future use.

For example, if a store has 15 open hours (working hours) each day, there will be 15 data points to be calculated for each day. The total data points will be 105 for a weekly sales baseline of each UPC.

The sales baseline built by the previous method does not include special day impact. Special day impacts are derived separately according to the present invention and applied to adjusting estimated future sales.

Special day incremental sales adjustment factor measures how much a special event impacting on the sales of a particular product or UPC. Normally, such impacts are mostly positive and will increase store sales comparing to a normal day.

A method according to the present invention for deriving an incremental sales impact factor for a UPC consists of the following steps: (a) identifying the type of special days, such as promotions, local events, extreme weather conditions, and holidays; (b) calculating the incremental sales for each type of special days by subtracting the daily baseline sales from the average sales on the special days to get average incremental sales for the special days; and (c) dividing the average incremental sales by the daily baseline sales respectively to get the incremental sales impact factors for each type of special days.

After obtaining sales baselines and special day incremental sales impact factors, future sales at any given day and given time can be predicted by applying the sales baselines to get estimated base sales and by applying the special day impact factors to get estimated incremental sales, and then combining the base sales and incremental sales to get the predicted future sales at the given day and given time.

Such sales baselines and special day impact factor can be used for future shelf stock status prediction to be discussed in later sections. They are also particularly useful for store sales management. For example, if an extreme weather condition is forecasted for near future days, the store manager can estimate what products will be on high demand by applying the special weather impact factors to adjust forecasted sales on the special weather days and make appropriate arrangement for the extreme weather event.

### Example 5

Methods for predicting future shelf stock status at UPC level are explained in detail below.

To predict UPC future shelf stock capacity, the system considers current item count on shelf, the shelf stock replenishment schedule, estimated future sales volume. The following priority should be followed: if there is a scheduled shelf replenishment event immediately before the future considered time, the shelf stock capacity should be reset to full or 100% at the scheduled replenishment time. Then, estimation of future sales continues from the time of reset. If there is no replenishment, the future shelf stock capacity can be calculated by the following steps: (a) calculating estimated future baseline sales according to the sales baseline patterns; (b) calculating incremental sales if the future time is in a special day like a major promotion by applying appropriate special day impact factors; (c) calculating the estimated total future sales by adding the estimated future baseline sales and the incremental sales; (d) calculating future shelf stock item count by subtracting the estimated total future sales from current shelf stock item count; and (e) calculating future shelf stock capacity by dividing the future shelf stock item count by full stock item count.

Further, future UPC shelf stock alert level can be assigned according to the predicted future shelf stock capacity. Furthermore, future UPC shelf stock empty index can be derived according to the future shelf stock alert levels. The methods for assigning UPC shelf stock alert level and deriving UPC shelf stock empty index have been described in Example 1.

The predicted future UPC shelf stock alert level and empty index can be displayed along with current UPC status to alert store management. The prediction can be made for next few hours for fast movement products or for next few days for slow movement products to give store management a clear picture of future shelf stock status.

### Example 6

Methods for predicting future shelf stock status at store level are explained in detail below.

A method according to the present invention for predicting future shelf stock empty index at store level consists of the following steps: (a) defining future shelf stock alert level for each UPC according to the methods described in Example 5; (b) counting the numbers of UPCs that are at shelf stock alert levels A, B, and C (the top 3 alert level) separately; (c) assigning a weight number to each alert level (the higher alert level, the larger weight); (d) calculating the weight adjusted grand total number of all UPCs at the top 3 alert levels; (e) dividing the weight adjusted grand total number by the total number of UPCs in the store for sales and the largest weight number (weight number for alert A) to get a relative number; and (f) multiply the relative number by a factor of 100 to get an index number between 0 and 100. This number is the empty index for the store at the given future time.

Accordingly, future shelf stock alert levels at store level can be assigned according to the shelf stock empty indexes for the stores, the larger the empty index, the higher the alert level.

### Example 7

Methods for reporting past shelf stock status are explained in detail below.

To report past shelf stock performances, according to the present invention a UPC period shelf stock empty index is used to represent overall UPC shelf stock status during a period of time in the past. A high UPC current shelf stock empty index number means a low shelf stock capacity during the time period.

A method according to the present invention for deriving period shelf stock empty index number during a past time period for a UPC consists of the following steps: (a) finding the time (hours) the UPC spent at each of the top 3 alert levels (A, B, and C) during the time period under consideration (such as in last day or last 7 days); (b) assigning a weight number to each alert level (the higher alert level, the larger the weight); (c) calculating the weight adjusted grand total time (hours) the UPC spent at the top 3 alert levels (A, B, and C); (d) dividing the weight adjusted grand total time by the total time of the period under consideration and the largest weight number (weight number for alert A) to get a relative number; and (e) multiply the relative number by a factor of 100 to get an index number between 0 and 100. This index number is the period shelf stock empty index for the UPC in the considered past time period.

A method according to the present invention for deriving period shelf stock empty index during a past time period for a store consists of the following steps: (a) calculating total time (hours) of all UPCs spent at each of the top 3 alert levels (A, B, and C) during the considered time period; (b) assigning a weight number to each alert level (the higher alert level, the larger weight); (c) calculating weight adjusted grand total time for all UPCs spent at the top 3 alert levels (A, B, and C); (d) dividing the weight adjusted grand total time by the total time of the period under consideration, the total number of UPCs, and the largest weight number (weight number for alert A) to get a relative number; and (e) multiply the relative number by a factor of 100 to get an index number between 0 and 100. This index number is the period shelf stock empty index for the store during the considered past time period.

### Example 8

Methods for monitoring shelf item freshness status at UPC level are explained in detail below.

Freshness of perishable products, especially perishable food, can be measured by freshness scores and expiration alert level according to the present invention. Freshness score emphasizes more on the product freshness while the expiration alert level more emphasized on on how severe a perishable product is out-of-date or near out-of-date on a store front shelf.

In order to track the freshness status of shelf items, a uniquely identification number is needed for each individual item. This can be achieved by several means. Radio frequency identification system is one of the promising techniques. However, it has not been widely used in the grocery industry partly due to its limitations for many of the grocery products. Other viable approaches include using an additional barcode along with the commonly used UPC barcode or using barcodes that can contain perishable product production date and expiration date. Database and computer programs can be configured to cross reference production date and expiration date of each unique item. The following discussions relating to perishable product freshness assume such unique product identification information is available and their production date and expiration date information can be retrieved from a database.

Freshness score for individual item is calculated by dividing the number of days from current date (such as today) to the expiration date (best consumed day, or sell-by-date for certain products) by the number of days from the production date (on-shelf date, or open-date for certain products) to the expiration date, and then multiplying the result by a factor of 100 to get an number between 0 and 100 as the individual item's freshness score.

For example, if there is a box of eggs on a shelf and the box is marked “Sell by Aug. 20, 2008”, we can calculate the freshness score for the box of eggs based on egg shelf life and the day under consideration. If the egg shelf lifetime is 20 days and today is Aug. 11, 2008, the freshness score for this box of eggs is 45 today. One week later from today, the freshness score for the same box of eggs will be 20. After 10 days from today, the freshness score will be 0, which means the eggs are out of date and they should be taken off the shelf.

Freshness score for a UPC is derived by calculating simple or weighted average freshness score of individual items within the UPC displayed on a store front shelf. Preferably, weighted average freshness score is used in order to emphasize the impacts of out-of-date products on the product freshness. More preferably, higher weights are assigned to items closer to their expiration dates during the calculations.

Freshness scores are particularly useful for monitoring perishable product freshness status for cross product freshness comparison. Alternatively, expiration alert levels can be used to indicate how close the products are to expiration.

A method according to the present invention for assigning an expiration alert level to a UPC consists of the following steps: (a) calculating freshness scores for each individual item of the UPC displayed on a store front shelf; (b) assigning an alert level to each item according to its freshness score (the lower the freshness score, the higher the alert the level); (c) assigning a weight number to each alert level (the higher the alert level, the larger the weight number); (d) calculating the weight adjusted grand total number (the sum of the item count at each alert level times the weight of that level); (d) dividing the weight adjusted grand total number by the total item count of the UPC and the largest weight number (the weight number for the highest alert level), and then multiplying by 100 to get an overall expiration alert index number between 0 and 100; and (e) assigning an overall alert level to the UPC according to the priority of the number of items that have been out-of-date, the number of items that are near out-of-date, and the overall expiration alert index number (the larger the index number, the higher the alert level).

### Example 9

Methods for monitoring shelf item freshness status at store level is explained in detail below.

A method according to the present invention for deriving perishable product shelf stock freshness score at store level consists of the following steps: (a) calculating UPC freshness score for each perishable product (UPC) according to methods described in Example 8; (b) assigning a weight number to each perishable product (UPC) according to importance of the product determined by store management; and (c) calculating the weighted average freshness score by including all perishable products. The weighted average freshness score is the overall shelf stock freshness score for the store.

A method according to the present invention for deriving store level overall perishable product expiration alert level consists of the following steps: (a) counting the numbers of perishable products (UPCs) that are at the top 3 expiration alert levels (A, B, and C); (b) assigning a weight number to each alert level (the higher the alert level, the larger the weight); (c) calculating weight adjusted grand total number for all products that are at the top 3 alert levels; (d) dividing the weight adjusted grand total number by the number of perishable products in the store under consideration and the largest weight number (the weight number for alert A) to get a relative number; (e) multiplying the relative number by a factor of 100 to get an number between 0 and 100 (this number is the overall expiration alert index for the store); and (f) assigning an overall expiration alert level to the store according to the overall expiration alert score (the higher the score, the higher the alert level).

### Example 10

Methods for simulating product sales in retail stores are explained in detail below.

The simulator according to the present invention is capable of generating 2 types of basic store sales data: UPC item sales and shopping basket sales. UPC item sales simulation means the simulator generates the numbers of items of each UPC being sold at given time intervals. For example, it can generate an item count number for how many bottles of 1% milk are sold at given times. The number of sold items can be generated for predefined time interval, such as for every 10 minutes. Shopping basket sales simulation means the simulator generates sales data by baskets as if customers are checking out at the registers. Each basket will contain multiple product items.

Alternatively, the simulator can generate store future sales at higher product hierarchy levels such as at group of UPCs, category, section, department, or store levels.

The simulations are based on store historical sales data and are dynamically adjusted for special day impacts such as planned promotions, special local events, extreme weather conditions, and holidays.

Alternatively, the simulation can be based on historical sales data from a group of stores with similar demographic patterns. Such simulation data is useful for new store location selection or market competition analysis.

A method according to the present invention for generating store sales data at UPC level consists of the following steps: (a) retrieving a sales baseline pattern for the UPC from database tables which are built from store historical sales data described in Example 4; (b) retrieving special day incremental sales adjustment factor for the UPC for making adjustment of simulated baseline sales data; (c) calculating estimated base (unadjusted sales) sales volume in the given time period; (d) calculating incremental sales volume by incorporating the special day adjustment factor; (e) combining the estimated base sales volume and the incremental sales volume to get the adjusted total sales volume for the given time period; (f) using a random number function to generate a series of random numbers; (g) using the random numbers to generate a series of random sales volumes based on predefined criteria; (h) adjusting the random sales volumes to make the total of the random sales volumes equals to the estimated total sales volume during the given time period; (i) repeating the steps a to h for each UPC to generate a complete dataset for all UPCs; (j) saving the simulated sales dataset to database; and (k) repeating the steps of a to j for another given time to generate another new dataset.

The simulation process can be executed independently to generate a dataset table for later used by other applications. In this simulation mode, the simulation process can be accelerated by incorporating time scale factors to generate large sets of sales data in a shorter time. It can also be synchronized with other applications for live data feeding. In this mode, the simulator generates predicted sales data in real time.

To generate shopping basket data, 2 additional baseline patterns are needed for the simulation. One is basket size distribution pattern. The other is basket items correlation pattern. Both baseline patterns can be built from store historical shopping basket data by commonly used statistical methods.

A method according to the present invention for generating shopping baskets at store level consists of the following steps: (a) retrieving store baseline sales pattern for all UPCs; (b) retrieving special day incremental sales impact factors for all UPCs; (c) calculating estimated base (unadjusted sales) sales for the given time period for each UPC; (d) calculating incremental sales for each UPC by incorporating the special day incremental impact factors; (e) combining the estimated base sales and the incremental sales to get the adjusted sales for each UPC during the given time period; (f) using a random number function to generate a series of random numbers for generating random baskets; (g) using another random number function to generate another series of random numbers for controlling basket sizes according to the store historical basket size distribution pattern; (h) using another random number function to generate another series of random numbers for controlling basket items according to store historical basket items correlation pattern; (i) generating a series of shopping baskets according to the random numbers and baseline patterns; (j) adjusting the randomly generated baskets to make the total sales equal to the adjusted sales for each UPC during the given time period; (k) saving the simulated sales dataset to database; and (k) repeating the steps of a to k for another given time period to generate another new shopping basket dataset.

A number of embodiments of the invention have been described. Nevertheless, it will be understood that various modifications may be made without departing from the spirit and scope of the invention. The scope of the invention is given by the appended claims, rather than the preceding description, and all variations and equivalents which fall within the range of the claims are intended to be embraced therein.

What is claimed is:

1. A system being operable of: (a) monitoring retail store front shelf stock capacity in real time, presenting shelf stock status by a plurality of symbols to visually enhance awareness of out-of-stock and low stock products at product, category, department, and higher product hierarchy levels; (b) monitoring perishable product freshness on retail store front shelves in real time, presenting product freshness by a plurality of symbols to enhance awareness of out-of-date or near out-of-date product items at product, category, department, and higher product hierarchy levels; (c) predicting future shelf stock capacity in real time, presenting future shelf stock status by a plurality of symbols to visually enhance awareness of out-of-stock and low stock shelf status at product, category, department, and higher product hierarchy levels; (d) reporting retail store front shelf stock status based on analysis of historical shelf stock data recorded by the said system, visually presenting stock capacity and duration, out-of-stock alter levels, empty index, and other shelf performance indexes for given products at product, category, department, and higher product hierarchy levels for given time periods; and (e) issuing warning alerts for out-of-stock or near out-of-stock, and out-of-date or near out-of-date products to notify store managers or other relevant personnel for taking appropriate actions.

2. The system according to claim 1, wherein comprising a plurality of user interfaces: (a) high level summary pages presenting companywide store level performance data for current shelf stock status, future shelf stock status, and products freshness status, where charts, tables, and maps being used to organize the data in easy to understand formats; (b) store level maps presenting current shelf stock or freshness status of products in an user selected store, where the store map can selectively display product locations, current product shelf status, future shelf stock status, and product freshness status by a combination of symbols, signs, and texts to enhance visual presentation of product shelf stock and freshness on store front shelves; (c) detail shelf stock status pages presenting current shelf stock item quantity, shelf capacity, shelf stock empty level, out-of-stock warning signs, item freshness, item expiration warning signs for an user selected store; (d) analytical reporting pages displaying shelf stock performance reports and allowing users to retrieve historical shelf stock status data from the said system for conducting user-defined analyses.

3. The system according to claim 1, wherein further comprising a data interface being operable of: (a) receiving or acquiring data from store front shelf stock replenishment system, store front point-of-sales transaction system, and store backroom product inventory system in real time or at predetermined time intervals; (b) processing the received or acquired data by computer programs automatically to turn the data to ready-to-use formats; (c) feeding the processed data to the said system for data processing or live display; and (d) saving the processed data into database for later use.

4. The system according to claim 1, wherein comprising a component (subsystem) for processing product shelf stock status data and product freshness status data, and assigning product shelf stock alert levels and product freshness alert levels according to predefined criteria and mathematic formulas.

5. The system according to claim 1, wherein comprising a component (subsystem) for simulating store sales data based upon store historical sales data.

6. The system according to claim 1, wherein comprising a component (subsystem) for predicting store future sales at product level, category level, or at other higher product hierarchy levels based upon store historical sales data and current shelf stock data; the said component can intelligently adjust product sales impacted by special days (e.g., major promotion, local events, extreme weather conditions, major holidays) to get more accurate prediction.

7. A store map being capable of visually presenting product locations and their shelf stock status by shapes, symbols, texts, and flashing color signs, and being interactive to provide users with additional information or navigate users to related pages.

8. The store map according to claim 7, wherein being capable of selectively displaying one or more types of information related to the products, including but not limited to product names, product shelf locations, shelf stock item counts, shelf stock capacity, shelf stock empty index, out-of-stock alert signs, perishable products freshness level, and perishable product expiration alert signs.

9. The store map according to claim 7, wherein being capable of displaying shelf stock status at higher product hierarchy levels, including but not limited to category level, department level, and store level.

10. A method for constructing product (represented by its universal package code, UPC) sales baselines and special day incremental sales impact factors from store historical sales data.

11. The sales baselines according to claim 10, wherein comprising daily sales baseline which consists of sales pattern within working hours of a day, weekly sales baseline which consists of 7 day sales pattern in a week, yearly sales baseline which consists of 365 day sales pattern in a year, and the combination of the said sales baselines which consists of detailed sales pattern for each working hour of each day of each week in a year.

12. The sales baselines according to claim 10, wherein being constructed from historical sales data for each product in a store, or from historical sales data for a product or a group of products in plurality of stores that have similar sales patterns.

13. The sales baseline according to claim 10, wherein having special days (e.g., major promotions, special local events, extreme weather days, and major holidays) sales data excluded during construction of the said sales baselines.

14. The method according to claim 10 for deriving a weekly UPC sales baseline pattern comprising steps of: (a) retrieving historical UPC sales data excluding special days (e.g., major promotions, special local events, extreme weather days, holidays) for a given retail store; (b) aggregating the UPC sales data in predefined time intervals (minutes, hours, days) to generate UPC sales data set for given times in given days; (c) calculating average sales for each UPC at a given time of a given day in a week in different seasons; and (d) saving the calculated average sales data in a database table for each UPC to form the said UPC sales baseline patterns for later use.

15. The special day incremental sales impact factors according to claim 10, wherein being calculated by the following steps: (a) identifying the type of special days (promotions, local events, extreme weather conditions, and holidays); (b) calculating the incremental sales for each type of special days by subtracting the daily baseline sales from the average sales on the special days to get average incremental sales for the special days; and (c) dividing the average incremental sales by the daily baseline sales for each type of special days respectively to get the incremental sales impact factors for the special days.

16. A method for estimating product (represented by its universal package code, UPC) future sales, comprising steps of: (a) calculating future base sales volume for a given future time in a future day according to the product sales baseline pattern which is prebuilt from store historical sales data; and (b) calculating incremental sales volume if the future time is in a special day (e.g., major promotions, local events, extreme weather conditions, and major holidays) by applying an appropriate special day incremental sales impact factor to the estimated future base sales volume; and (c) adding the estimated future base sales volume and the special day incremental sales volume to get the total sales volume for the given future time.

17. A method for deriving product shelf stock empty index for measuring shelf stock status during a certain period of time, wherein the said empty index for a product (represented by its universal package code, UPC) is derived from its shelf stock alert levels and duration in the time period under consideration, while the said index for a higher product level (e.g., at store level) is derived from the shelf stock alert levels and the duration at each alert level of a lower level product (e.g., at UPC level).

18. The shelf stock alert level of a product according to claim 17, being defined according to its shelf stock capacity (the actual item count on shelf divided by the item count at full stock) at any given time, where the lower the shelf capacity, the higher the alert level, preferably a five-level alert system (e.g., A, B, C, D, and E for representing shelf stock from empty to full) is used.

19. The method according to claim 17 for deriving period shelf stock empty index number for a given product (UPC), wherein consisting of the following steps: (a) finding the length of time (hours) the UPC spent at each of the top 3 alert levels (A, B, and C) during the time period under consideration (such as in last day or last 7 days); (b) assigning a weight number to each alert level (the higher alert level, the larger the weight); (c) calculating the weight adjusted grand total time (hours) the UPC spent at the top 3 alert levels (A, B, and C); (d) dividing the weight adjusted grand total time by the time of the period under consideration and the largest weight number (weight number for alert A) to get a relative number; and (e) multiply the relative number by a factor of 100 to get an index between 0 and 100.

20. The method according to claim 17 for deriving period shelf stock empty index at store level, consisting of the following steps: (a) calculating total time (hours) of all products (UPCs) spent at each of the top 3 alert levels (A, B, and C) during the considered time period; (b) assigning a weight number to each alert level (the higher alert level, the larger weight); (c) calculating weight adjusted grand total time for all UPCs spent at the top 3 alert levels (A, B, and C); (d) dividing the grand total time by the time of the period under consideration, the total number of UPCs, and the largest weight number (weight number for alert A) to get a relative number; and (e) multiply the relative number by a factor of 100 to get an index number between 0 and 100.

21. A method for deriving product freshness score for measuring perishable product shelf stock freshness and assigning expiration alert level for issuing alerts for out-of-date or near out-of-date products, wherein the said expiration alert level for a product (UPC) is derived from the freshness score of individual product items of the UPC while the said expiration alert level for a higher level product (e.g., at store level) is derived from the shelf stock expiration alert levels of a lower level product (e.g., at UPC level).

22. The freshness score of individual item according to claim 21, being calculated by dividing the number of days from current date (e.g., today) to the expiration date (best consumed day, or sell-by-date) by the number of days from the production date (on-shelf date, open-date, or packaged date) to the expiration date, and then multiplying the result by a factor of 100 to get a number between 0 and 100.

23. The method according to claim 21 for assigning an expiration alert level to a product (UPC), wherein consisting of the following steps: (a) calculating freshness scores for each individual item of the UPC displayed on store front shelf; (b) assigning an alert level to each item according to its freshness score (the lower the freshness score, the higher the alert the level); (c) assigning a weight number to each alert level (the higher the alert level, the larger the weight number); (d) calculating the weight adjusted grand total number (the sum of the item count at each alert level times the weight of that level); (d) dividing the weight adjusted grand total number by the total item count of the UPC and the largest weight number (the weight number for the highest alert level) and then multiplying by 100 to get an overall expiration alert index number between 0 and 100; and (e) assigning an overall alert level to the UPC according to the priority of the number of items that have been out-of-date, the number of items that are near out-of-date, and the overall expiration alert index number (the larger the index number, the higher the alert level), preferably a five-level alert system (e.g., A, B, C, D, and E for representing freshness from the worst to best) is used.

24. The method according to claim 21 for deriving store level overall perishable product expiration alert level, wherein consisting of the following steps: (a) counting the numbers of perishable products (UPCs) that are at the top 3 expiration alert levels (A, B, and C as defined according to the method of claim 23); (b) assigning a weight number to each alert level (the higher the alert level, the larger the weight); (c) calculating weight adjusted grand total number for all products that are at the top 3 alert levels; (d) dividing the weight adjusted grand total number by the number of perishable products in the store under consideration and the largest weight number (the weight number for alert A) to get a relative number; (e) multiplying the relative number by a factor of 100 to get an number between 0 and 100 (this number is the overall expiration alert index for the store); and (f) assigning an overall expiration alert level to the store according to the overall expiration alert index (the higher the index, the higher the alert level).

25. A system being operable of simulating product sales and shopping basket sales data at given time intervals in real time or at accelerated time scale, where the said system can operate independently or be integrated with other systems such as the one described in claim 1.

26. The system according to claim 26, further being operable of simulating store sales data at higher product hierarchy levels including but not limited to category level, department level, and store level.

27. The system according to claim 26, wherein being operable of simulating sales data according to store historical sales baselines and automatically adjusting sales impacts by special days (e.g., major promotions, special local events, extreme weather conditions, and major holidays).

28. A method for simulating store product (represented by its universal package code, UPC) item sales, consisting of the following steps: (a) retrieving a sales baseline pattern for a given product (UPC) from database; (b) retrieving special day incremental sales impact factor for the given product from database; (c) calculating estimated base (unadjusted sales) sales volume in a given time period (time interval) at given time; (d) calculating incremental sales volume by multiplying the estimated base sales volume with the special day increment sales impact factor; (e) combining the estimated base sales volume and the incremental sales volume to get the adjusted total sales volume for the given time period; (f) using a random number function to generate a series of random numbers; (g) using the random numbers to generate a series of random sales volumes based on predefined criteria; (h) adjusting the random sales volumes to make the total volume of the random sales volumes equals to the estimated total sales volume during the given time period; (i) repeating the steps a to h for each product (UPC) to generate a complete dataset for all products; (j) saving the simulated sales dataset to database; and (k) repeating the steps of a to j for another given time to generate another new dataset.
